(19) United States
(12) Patent Application Publication
(10) Pub. No.: US 2021/0041143 A1
(43) Pub. Date: Feb. 11, 2021

(54) ELECTRIC WATER HEARING APPARATUS

(71) Applicant: Franco Diederiks, Krugersdorp (ZA)

(72) Inventor: Franco Diederiks, Krugersdorp (ZA)

(21) Appl. No.: 16/977,571

(22) PCT Filed: Nov. 2, 2018
(86) PCT No.: PCT/IB2018/058605

§ 371 Date: Sep. 2, 2020

(30) Foreign Application Priority Data
Mar. 13, 2018 (ZA) 2018/01702

(51) Int. Cl. F24H 4/04; F24H 1/18; F24D 17/00; F28D 20/00; F28D 1/047

(52) U.S. Cl. CPC F24H 4/04; F24H 1/182; F24D 2200/12; F28D 20/0034; F28D 1/0477; F24D 17/0036

(57) ABSTRACT

There is disclosed an electric water heating apparatus (10) comprising a water reservoir (12) having a closable aperture for receiving water therein; a heat pump assembly (14) including at least a portion of a condenser coil (16) located inside the water reservoir (12), operatively enabling a compressed refrigerant to flow through the condenser coil (16) for heat exchange to take place between the condenser coil (16) and the water inside the reservoir (12) to heat the water inside the reservoir (12); a water heating conduit (18) extending at least partly through the water in the water reservoir (12), operatively conveying water there through between an inlet (20) and an outlet (24) and being in fluid communication with a water reticulation network, for water passing though the water heating conduit (18) to be indirectly heated via heat transfer from heated water inside the water reservoir (16).

### FIELD OF THE INVENTION

This invention relates to an electric water heating apparatus.

### BACKGROUND TO THE INVENTION

Electrical water heaters are commonly used in residential, commercial and industrial applications. The conventional construction of these include a reservoir with a cold-water inlet and a hot-water outlet, an electrical heating element extending into the reservoir, and in the case of a sealed unit, also a pressure relief valve.

Sealed units are, for hygiene considerations, the norm for applications where the water is used for human consumption, such as for drinking, food preparation and washing. Sealed units build up internal pressure during heating of the water, and for this reason the materials from which they are manufactured have to be strong and able to withstand the pressures associated with heating water for such intended use. Such sealed units are considered pressure vessels.

Electrical current is passed through the heating element, which has a higher electrical resistivity than the rest of the electrical circuit and accordingly heats up. This increases the temperature of the metal heating element which transfers through contact to water surrounding it. The heating element is thus in direct contact with water that is heated by it and the entire configuration has to be kept sufficiently sterile when this is used for human consumption.

This causes such water heaters to be heavy, difficult to handle for installation and maintenance, and relatively expensive. Despite the strong materials that are used in their construction, such sealed heaters still rupture, often resulting in water damage to surrounding areas. This is also despite such heaters being installed on drip trays which are meant to catch and safely redirect water leaking from the heater.

Domestically and commercially such heaters are typically installed in ceilings, which results in property damage to the roof and ceiling, and whatever is located underneath it, if such a heater rupture. In high density domestic settings such as apartment blocks or flats, the damage caused by one incident of water heater failure may be to more than one household.

Heat pumps are also employed to heat water. Typically, a compressor compresses a refrigerant which increases the temperature of the refrigerant before allowing the refrigerant to pass through a condenser coil which is submerged in a water containing reservoir. Heat transfer takes place between the condenser coil and the surrounding water, with heat transferring from the refrigerant through the walls of the coil to the water that is in contact with the coil. This heats the water in the reservoir, and removes heat from the refrigerant, which can be recycled to be compressed again in a repeat of this process. The water may then be dispensed from the reservoir from the hot-water outlet for distribution through a reticulation network.

In a heat pump configuration, the coil is effectively the heating element which is in direct contact with the water that it heats. It differs from a conventional electrical heating element in that the tubular coil is heated by the hot refrigeration that passes through it, as opposed the solid metal coil that heats up due to resistivity to electrical current passing through it.

The element and coil both contact the water that they heat. However, fouling of especially the condenser coil often takes place over prolonged periods of use. Of particular health risk is the biological fouling in the form of bacteria and/or algae flourishing at, or about, the condenser coil. Such bacteria and/or algae may end up in domestic drinking water which could have severe health risks. Furthermore, heated water emanating from a heat pump water heating apparatus is typically not under high pressure and results in such apparatuses having limited use. For example, use in apartment blocks and/or commercial buildings may be somewhat limited owing to the low pressure.

There is a need for an electric water heating apparatus that at least partly overcomes the disadvantages described above and/or otherwise known from the prior art.

### OBJECT OF THE INVENTION

It is an object of the invention to provide an electric water heating apparatus which at least partly overcomes the abovementioned problems.

### SUMMARY OF THE INVENTION

In accordance with this invention there is provided an electric water heating apparatus comprising:
a water reservoir having a closable aperture for receiving water therein;
a heat pump assembly including at least a portion of a condenser coil located inside the water reservoir, operatively enabling a compressed refrigerant to flow through the condenser coil for heat exchange to take place between the condenser coil and the water inside the reservoir heating the water inside the reservoir;
a water heating conduit extending at least partly through the water in the water reservoir, operatively conveying water therethrough between an inlet and an outlet and being in fluid communication with a water reticulation network, for water inside the water heating conduit to be indirectly heated via heat transfer from heated water inside the water reservoir.

The water reservoir may include an outer sleeve and an inner sleeve. The water reservoir may optionally include first outlet to allow in use an overfilled reservoir to be drained of excess water.

The inner sleeve of the water reservoir may be manufactured from a plastics containing material. The plastics containing material may be a fibre reinforced plastics containing material, preferably fibreglass.

The outer sleeve of the water reservoir may be provided as an insulation layer. Typically, the insulation layer is comprised of a plastics material, preferably polyurethane and/or polystyrene and/or a derivative thereof. The inner sleeve may be spray coated to provide the outer sleeve. The insulation layer limits heat loss to an external environment from water inside the water reservoir heated by the condenser coil of the heat pump assembly.

The heat pump assembly may include a support from which the condenser coil depends spirally, downwardly into the water reservoir and upon which a compressor and a refrigerant source may be located superposingly above a top end of the water reservoir.

In use, the condenser coil receives compressed refrigerant from the compressor allowing said compressed refrigerant to flow spirally and downwardly before flowing back up, optionally via an expansion valve and optionally via an evaporator, back to the compressor. It is to be understood that the heat pump assembly may be of a type known in the art to the skilled person.

The condenser coil may, in a certain embodiment of this disclosure, be ribbed to facilitate turbulent flow of water therethrough and/or to limit scale accumulation and/or to limit biological fouling.

The water heating conduit may spiral around the condenser coil that depends downwardly into the water reservoir. The water heating conduit may be adapted to provide an inner spiral and an outer spiral.

The spiralling water heating conduit may be of a predetermined length to allow water passing therethrough to be indirectly heated to a predetermined temperature ensuring the heated water exiting the second outlet is at the predetermined temperature and ready for use throughout the water reticulation network. The predetermined temperature may be any temperature within a range from about 15° C. to about 75° C. Preferably, the range is between about 35° C. and 65° C.

The water heating conduit may, in a certain embodiment of this disclosure, be ribbed to facilitate turbulent flow of water therethrough and/or to limit scale accumulation and/or to limit biological fouling.

The water heating conduit may be mounted to a framework. The framework may include a series of uprights mounted between a bottom end piece and a top end piece, each upright may define recesses along its length to receive the water heating coil as it spirals. In a preferred embodiment of the disclosure each upright is a rectangular strap wherein first and second lengths of each rectangular strap having there along a series of recesses to receive the inner and outer spiral, respectively.

The water heating conduit may be a stainless steel conduit. The water heating conduit may receive therein, via the second inlet, cold water under high pressure relative to the water in the water reservoir, such that in use, the heated water exiting the conduit is under high pressure for use throughout the water reticulation network.

In a certain embodiment of this disclosure, the second inlet and the second outlet are located proximal to the top end of the water reservoir having therebetween a downwardly spiralling portion and an upwardly spiralling portion. The downwardly spiralling portion may be proximal to the second inlet, and the upwardly spiralling portion may be proximal to the second outlet, such that as water inside the conduit is indirectly heated it spirals upwardly toward the second outlet.

In an alternative embodiment, the second inlet of the water heating conduit may be located proximal to a lower end of the water reservoir, and the second outlet of the water heating conduit may be located proximal to the top end of the water reservoir, such that in use, water that is indirectly heated rises upwardly toward the second outlet. Further alternative configurations are envisaged by the Applicant.

The electric water heating apparatus may further comprise a backup water heating element located within the water reservoir, preferably proximate a bottom end thereof, such that in use, should the heat pump assembly fail the water heating element will facilitate heating water inside the water reservoir.

The first and second inlet, the first and second outlet and the condenser coil may each include a valve operably regulating fluid flow therethrough. The valves may be electronically controlled.

The electric water heating apparatus may include at least one temperature sensor. The Applicant envisages that a first temperature sensor may be located within the water reservoir and a second temperature sensor may be located within the water heating conduit. The heat pump assembly may include a pressure sensor together with a pressure regulator, and/or a third temperature sensor and/or temperature regulator. Conventional heat pump assemblies may be employed.

The electric water heating apparatus may further include an electronic control system. The electronic control system may be in electronic communication with the heat pump assembly (particularly the compressor, the evaporator, and the condenser coil), the first and second inlet, the first and second outlet, the water heating element, and the temperature sensors.

It is to be understood that the electronic control system may be configured to ensure that the water inside the water reservoir is heated to a certain temperature in order to provide that water exiting the second outlet of the water heating conduit is indirectly heated to the predetermined temperature.

The electric water heating apparatus may further include a cowl to operably be received over the top end of the water reservoir and housing therein at least a portion of the heat pump assembly. Typically, the electronic control system is also located within the cowl.

The cowl may further be adapted to provide a vent to allow heat to be dissipated outwardly into the external environment.

The cowl may further comprise an air inlet to allow cool air to move into the cowl from the external environment.

The cowl may provide a recess to accommodate a control panel in electronic communication with the electronic control system.

The Applicant has found that the electric water heating apparatus according to this disclosure allows for indirect heating of water inside the water heating conduit such that said heated water may be at high pressure for use throughout the water reticulation network. The water reservoir remains under relatively low pressure when compared to the water inside the water heating conduit. Preferably, the water reservoir remains under near or substantially atmospheric pressure.

The low pressure heated water inside the reservoir is never contacted by an end user. As such, any biological fouling around the condenser coil and/or water heating conduit is not a risk for the end user. Periodically, the water inside the reservoir may be emptied via the first outlet, the reservoir may be cleaned, and fresh water may again be allowed fill the reservoir via the first inlet.

Having the water reservoir under constant low (atmospheric) pressure allows the manufacture of its inner sleeve to be of a plastics containing material, such as fibreglass. The invention ameliorates the need for a high strength metallic water reservoir which is ordinarily required to sustain a high-pressure environment. Consequently, the water reservoir is lightweight relative to an ordinary electric geyser, and is easy to install.

The electric water heating apparatus according to this disclosure allows for the production and use of high-pressure hot water heated via indirect means.

There is further provided for an apparatus substantially as herein described with reference to any one of the accompanying diagrammatic drawings.

These and other features of the invention are described in more detail below.

### BRIEF DESCRIPTION OF THE DRAWINGS

A preferred embodiment of the invention is described by way of example only and with reference to the accompanying drawings in which:

FIG. 1 shows a top perspective view of an electric water heating apparatus in accordance with this disclosure;

FIG. 2 shows a bottom perspective view of FIG. 1;

FIG. 3 shows a top view of FIG. 1;

FIG. 4 shows a bottom view of FIG. 1;

FIG. 5 shows a front view of FIG. 1;

FIG. 6 shows a back view of FIG. 1;

FIG. 7 shows a first side view of the electronic water heating apparatus shown in

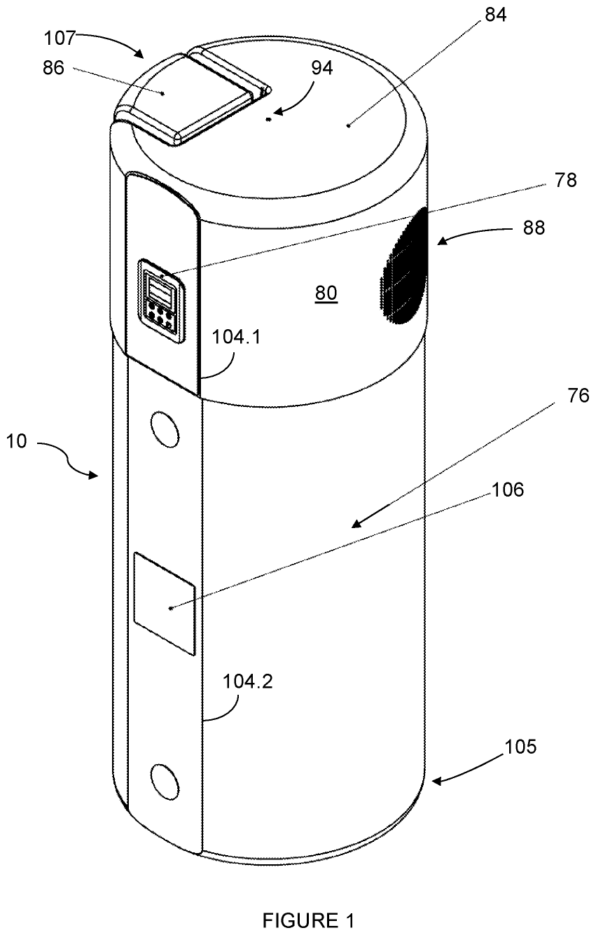

FIG. 1;

FIG. 8 shows a second opposite side view of the electronic water heating apparatus shown in FIG. 1;

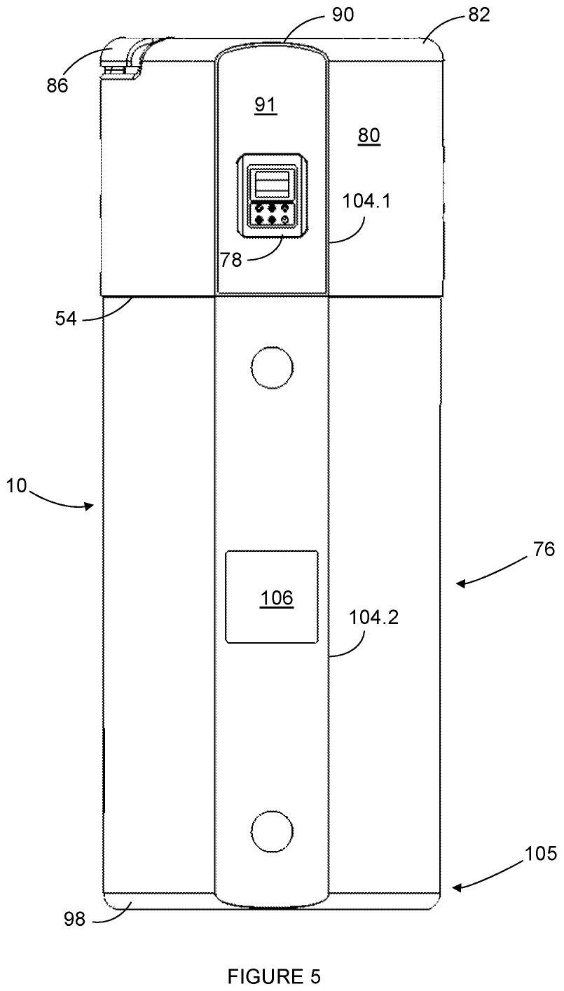

FIG. 9 shows the front view of FIG. 5 in cross section;

FIG. 10 shows the second opposite side view of FIG. 8 in cross section;

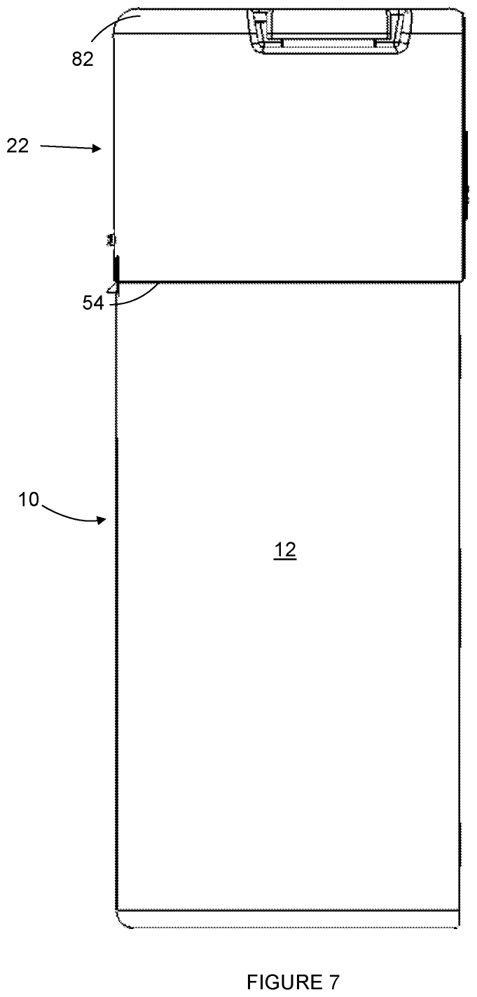

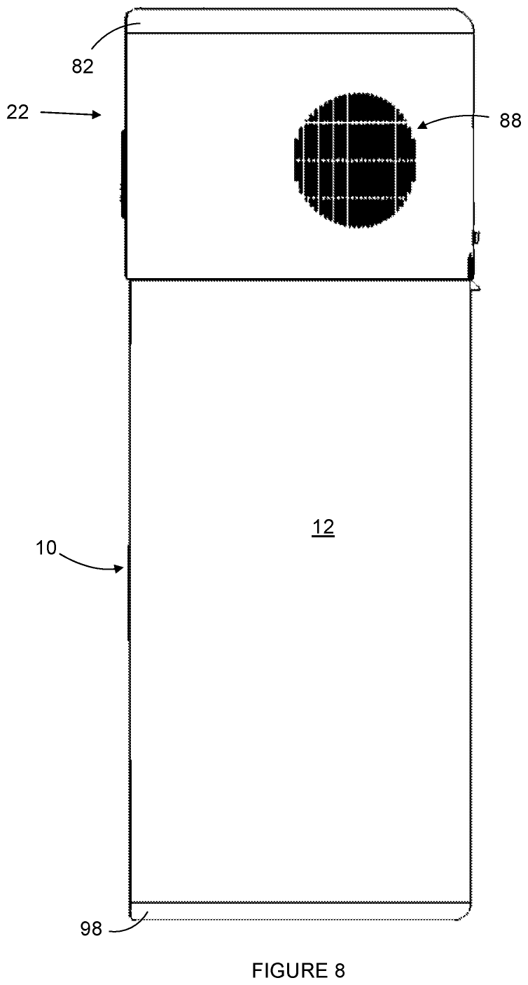

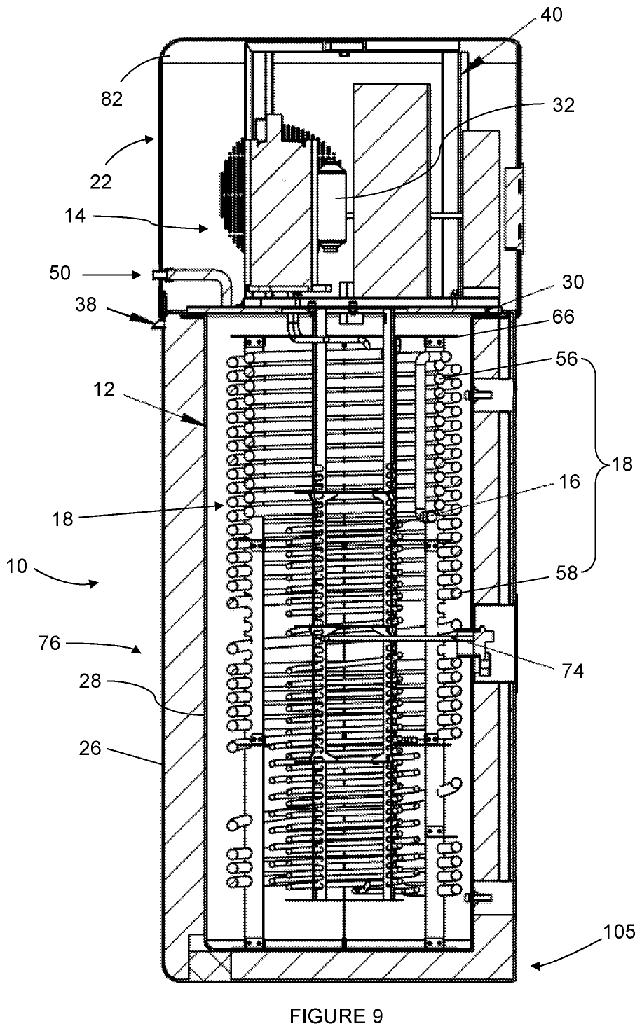

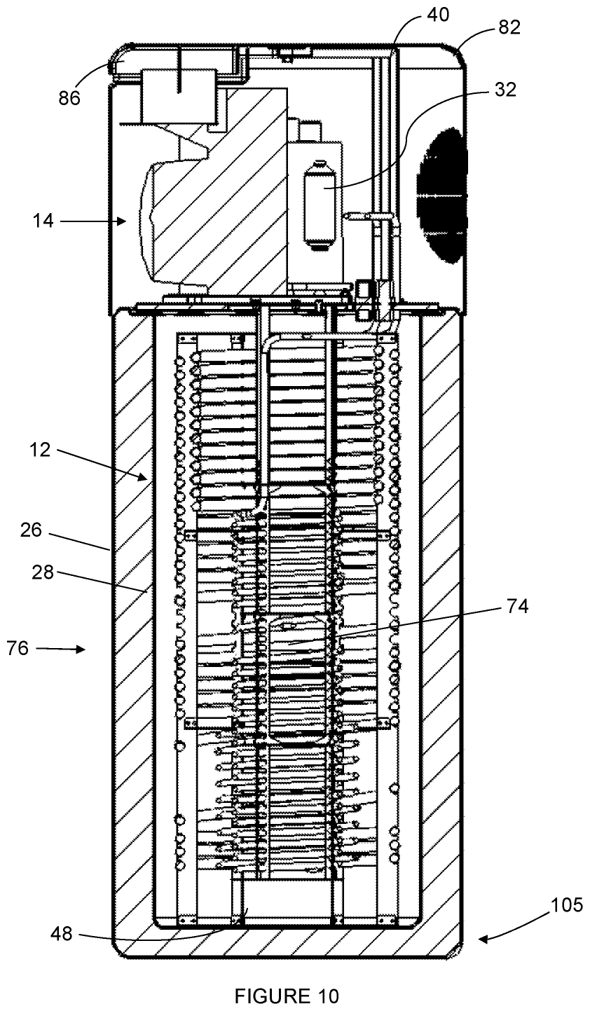

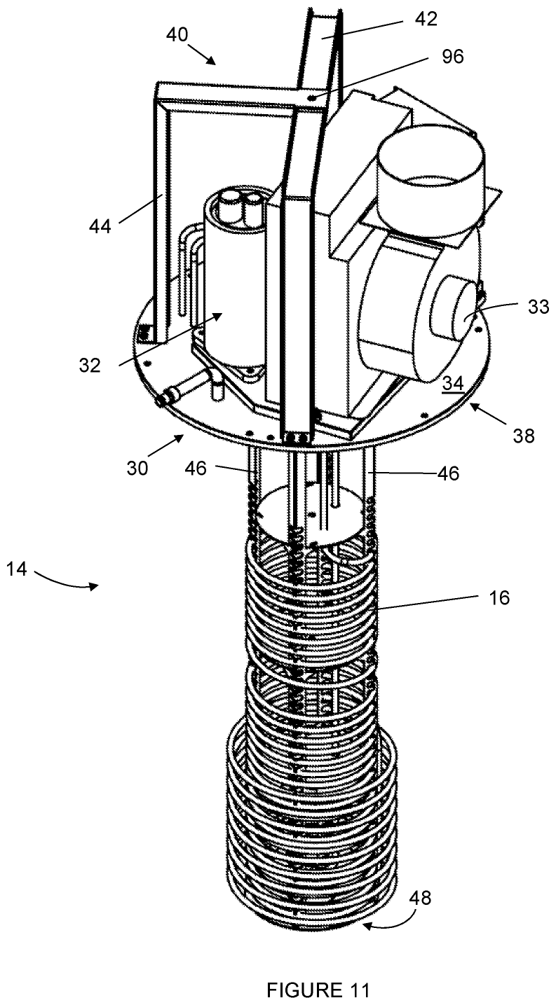

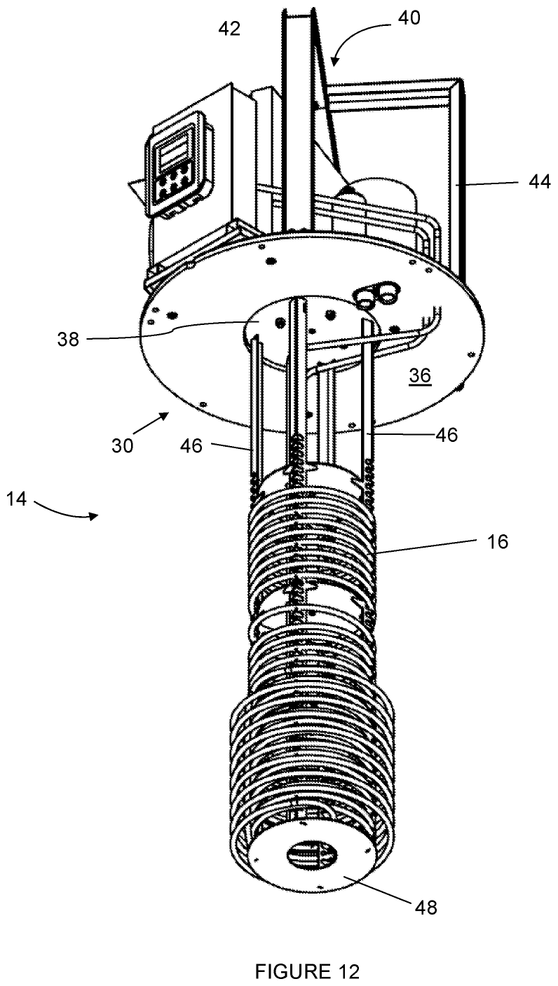

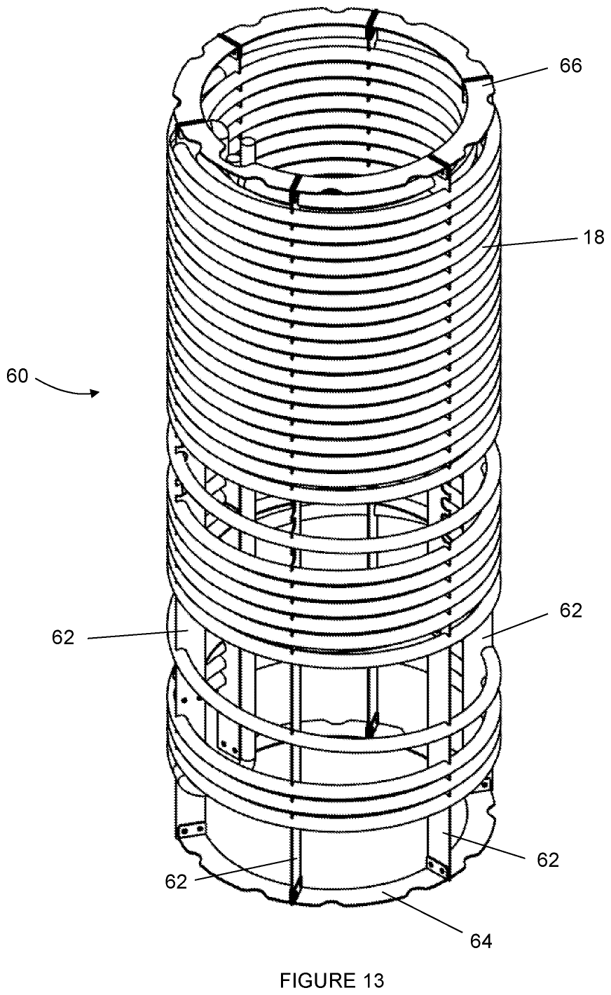

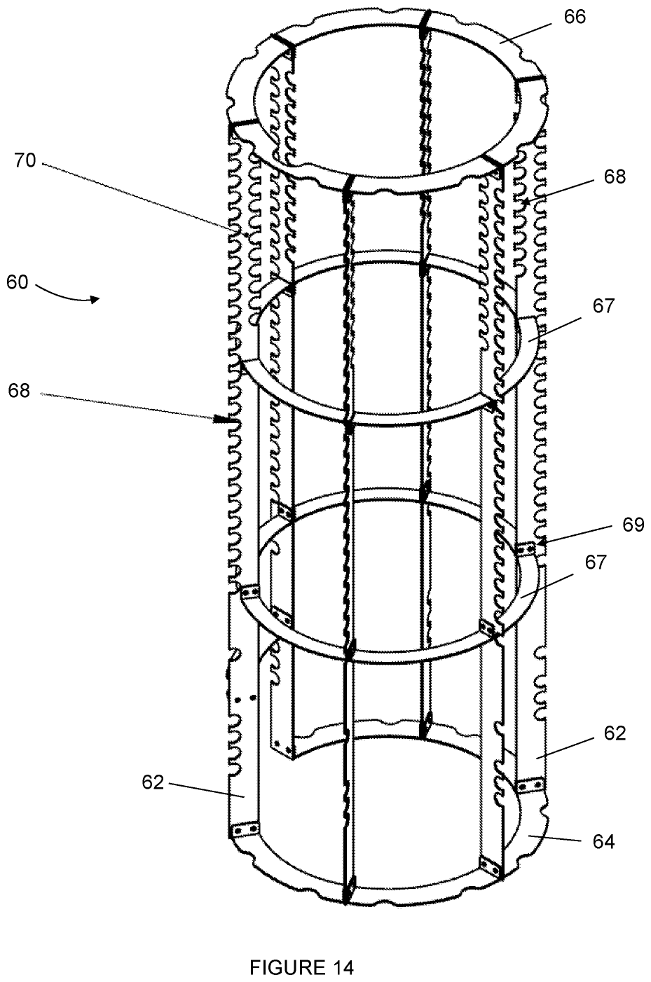

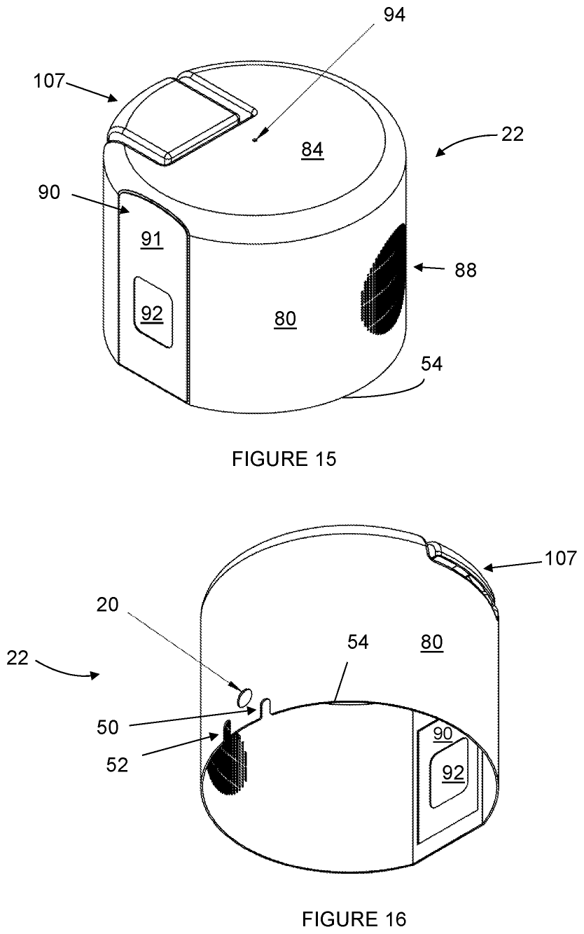

FIG. 11 shows a first perspective view of a heat pump assembly forming part of the electric water heating apparatus shown in FIGS. 1 to 10;

FIG. 12 shows a second perspective view of a heat pump assembly forming part of the electric water heating apparatus shown in FIGS. 1 to 10;

FIG. 13 shows a perspective view of a water heating conduit mounted to a framework forming part of a preferred embodiment of the electronic heating apparatus of this disclosure;

FIG. 14 shows the framework of FIG. 13 without the water heating conduit mounted thereto;

FIG. 15 shows a top perspective view of a cowl forming part of the electric water heating apparatus shown in FIGS. 1 to 10; and

FIG. 16 shows a bottom shows a top perspective view of a cowl forming part of the electric water heating apparatus shown in FIGS. 1 to 10.

### DETAILED DESCRIPTION OF THE INVENTION

Embodiments of an electric water heating apparatus according to the invention are described below by way of example only, and such embodiments should not be construed as limiting. The disclosures of the Summary above are repeated herein by reference thereto and may not be fully repeated to avoid unnecessary repetition.

FIGS. 1 to 10 show an electric water heating apparatus in different views, with the electric water heating apparatus generally having assigned reference number (10) to it. The electric water heating apparatus (10) is shown to be generally vertically cylindrical in its shape and/or configuration.

FIGS. 1 to 8 show the electric water heating apparatus (10) in differing views and ready for installation. Several components are located inside and will be discussed with reference to FIGS. 9 and 10 which show the water heating apparatus (10) in cross section. The electric water heating apparatus (10) is shown to be of the vertical type, and it is to be understood that same may be adapted to provide a horizontal embodiment.

As shown in FIGS. 9 and 10, the electric water heating apparatus (10) comprises a water reservoir (12), a heat pump assembly (14) including a condenser coil (16) centrally depending downwardly inside the water reservoir (12), and a water heating conduit (18). The water heating conduit (18) is located substantially inside the water reservoir (12) and substantially around the condenser coil (16).

Broadly, when the electric heating apparatus (10) is in use, compressed refrigerant flows through the condenser coil (16) and heat exchange takes place between the condenser coil (16) and the water inside the reservoir (12) heating the water inside the reservoir (12). The water heating conduit (18), which is located inside the water reservoir (12) conveys water therethrough and is in flow communication with a water reticulation network (not shown), the water inside the water heating conduit (18) is indirectly heated via heat transfer by the heated water inside the water reservoir (12).

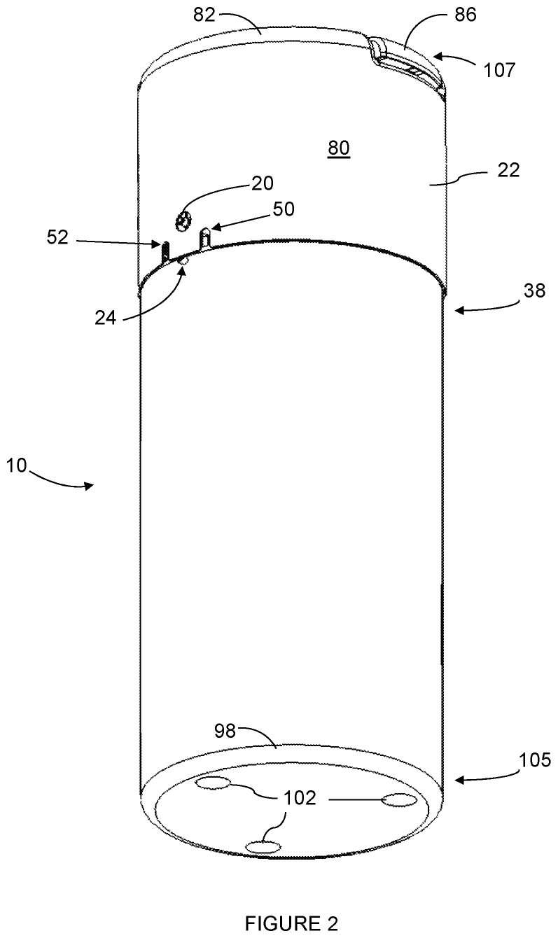

The water reservoir (12) has a first inlet (20) as shown in FIG. 2 as located through a portion of a sidewall of a cowl (22) located on top of the water reservoir (12) and housing therein at least a portion of the heat pump assembly (14). Typically, a pipe (not shown) conveys water through the first inlet (20) into the water reservoir (12). It is to be understood that the first inlet (20) may be located at different positions along the water reservoir (12) and/or cowl (22).

In a certain embodiment of this disclosure the water reservoir (12) may further include a first outlet (24) to allow for a discharge of water from the water reservoir (12) in the event of, for example, an overfilling of the reservoir (12) and/or increased pressure. The first outlet (24) is shown as located through the sidewall of the reservoir (12), however, it may also locate through the sidewall of the cowl (22). The outlet (24) is connected to a pipe (not illustrated) that extends downwardly into the reservoir (12).

As shown in FIGS. 9 and 10, the water reservoir (12) typically includes an outer sleeve (26) and an inner sleeve (28). The inner sleeve (28) of the water reservoir (12) is manufactured from fibreglass, and the outer layer (26) is a foam type insulation, preferably said foam type insulation including polyurethane. The foam insulation outer layer (26) limits heat loss to an external environment from water inside the water reservoir (12) heated by the condenser coil (16) of the heat pump assembly (14).

As shown in FIGS. 9 and 10, the heat pump assembly (14) may be mounted to a support (30) from which the condenser coil (16) depends spirally, downwardly into the water reservoir (12) and upon which a compressor (32) including therein a refrigerant source may be located superposingly above a top end (38) of the water reservoir (12). The support (30) includes a circular top plate (34) and a circular bottom plate 36, the circular top plate 34 providing a platform for the heat pump assembly (14) to seat upon and be fixed against, and the circular bottom plate (36) providing a seal against a top end (38) of the reservoir (12) such that water inside the reservoir (12) cannot readily contact electronic components mounted to the support (30) or mounted to the cowl (22). This is illustrated in FIGS. 11 and 12.

The support (30) may have extending upwardly away therefrom a bracket (40) having a U-shaped arm (42) connected at a mid-portion thereof to an L-shaped arm (44) as shown in FIGS. 11 and 12.

FIGS. 11 and 12 show the condenser coil 16 spiraling about four spaced rods 46 connected on either ends to the circular top plate 34 and a base plate 48. The rods 46 between the circular top plate 34 and the base plate 48 provide rigidity to the condenser coil 16.

When the electric water heating apparatus (10) is in use, the condenser coil (16) receives compressed refrigerant from the compressor (32) allowing said compressed refrigerant to flow spirally and downwardly in the direction of the base plate (48) from the compressor (32) before flowing back up, via an expansion valve (not visible) and via an evaporator (33), back to the compressor (32). It is to be understood that the heat pump assembly (14) may be of a type known in the art to the skilled person.

The condenser coil (16) may, in a certain embodiment of this disclosure, be internally ribbed to facilitate turbulent flow therethrough and/or to limit scale accumulation and/or to limit biological fouling. This is not shown in the Figures.

The water heating conduit (18) located inside the water reservoir (12) conveys water therethrough between a second inlet (50) and a second outlet (52) and in flow communication with a water reticulation network, the water inside the water heating conduit (18) indirectly heated via heat transfer by water inside the water reservoir (12).

FIGS. 2 and 16 show the cowl (22) providing the second inlet (50) and second outlet (52) as two adjacent recesses in a rim (54) of the cowl (22), each recess being generally rectangular with a rounded inner upper end.

Referring now to FIGS. 9 and 10, the water heating conduit (18) spirals around the condenser coil (16) that depends centrally downwardly into the water reservoir (12). The water heating conduit (18) is adapted to provide an inner spiral (56) and an outer spiral (58).

The spiraling water heating conduit (18) is of a predetermined length to allow water passing therethrough to be indirectly heated to a predetermined temperature ensuring the heated water exiting the second outlet (52) is at the predetermined temperature and ready for use throughout the water reticulation network.

The water heating conduit (18) may, in a certain embodiment of this disclosure, be internally ribbed to facilitate turbulent flow therethrough and/or to limit scale accumulation and/or to limit biological fouling.

Referring to FIGS. 13 and 14, the water heating conduit (18) is mounted to a framework (60). The framework (60) includes a series of upright supports (62) mounted between a bottom end piece (64) and a top end piece (66). Additional rings (67) between the bottom and top end pieces (64), (66) provide additional stability. The upright supports (62) are connected to the bottom end piece (64), the top end piece (66) and the additional rings (67) via connection means (69) in the form of bolts and nuts, alternatively rivets.

Each upright support (62) defines recesses along its length to receive the water heating coil (18) as it spirals. In a preferred embodiment illustrated in FIGS. 13 and 14, each upright support (62) is a rectangular strap wherein first and second lengths (70), (72) of each rectangular strap having there along a series of recesses (68) to receive the inner (56) and outer spiral (58), respectively. The first length (70) faces inwardly toward a center of the reservoir (12). The second length faces outwardly toward a wall of the inner sleeve (28).

In FIGS. 9 and 10, it is shown that the outer spiral (58) extends all the way along the second length (72) of the upright supports (62), and the inner spiral (56) is located toward an upper portion of the first length of the upright supports (62) only. Consequently, the recesses (68) extend along the whole length of the second length (72) and face outwardly toward a wall of the inner sleeve (28) of the reservoir (12), but the recesses (68) only extend along a upper portion of the first length (70) of the upright supports (62) and face inwardly toward a centre point of the water reservoir (12).

In a preferred embodiment of this disclosure, the water heating conduit (18) is manufactured from stainless steel. Typically, the water heating conduit (18) receives therein, via the second inlet (50), cold water under high pressure relative to the water in the water reservoir (12), such that in use, the heated water exiting the conduit (18) is under high pressure for use throughout the water reticulation network.

In FIGS. 9 and 10, the electric water heating apparatus (10) is shown to further comprise a water heating element (74). The water heating element (74) is essentially a backup heating element and is shown to be located within the water reservoir (12) proximate the centre (76) thereof. Should the heat pump assembly (14) fail then the water heating element (74) will facilitate heating water inside the water reservoir (12).

The electric water heating apparatus (10) may include at least one temperature sensor, electronically operated valves, and pressure sensors. Not all the components are illustrated in the figures.

The electric water heating apparatus (10) is shown to further include an electronic control system (78) having a front display and user interface seen in FIG. 1. The electronic control system (78) is in electronic communication with the heat pump assembly (14) (particularly the compressor (32), the evaporator (33), and the condenser coil (16)), the first inlet (20), the second inlet (50), the second outlet (52), the water heating element (78), and the temperature sensors (not shown).

It is to be understood that the electronic control system (78) may be configured to ensure that the water inside the water reservoir (12) is heated to a certain temperature in order to provide that water exiting the second outlet (52) of the water heating conduit (18) is at the predetermined temperature.

The cowl (22) shown in FIGS. 1 to 4 and 15 and 16, is operably received over the top end (38) of the water reservoir (12) and houses therein at least a portion the heat pump assembly (14) and the electronic control system (78). The cowl (22) has a generally round sidewall (80) and slightly rounds toward its top defining a circular rounded edge (82) before providing for a substantially flat circular top surface (84).

The cowl (22) includes a vent (80) to allow heat to be dissipated outwardly into the external environment. The vent (80) includes an aperture (not shown) and a lid (86). The lid (86) is formed as a portion of the edge (82) and top surface (84) and includes hinges to move the lid (86) between an open position (not shown) and a closed position (shown in FIG. 1). The shape and configuration of the lid (86) may vary. The vent (80) may alternatively, or additionally, include a pressure release valve, typically a one-way valve, to allow excess pressure and/or water vapor and/or gas to be vented.

As shown in FIGS. 1, 15 and 16, the cowl (22) is further shown to comprise an air inlet (88) in the form of a circular grill through the round sidewall (80) of the cowl (22). The grill (88) allows cool air to move into the cowl (22) from the external environment. As shown in FIGS. 15 and 16, the rounded sidewall (80) defines a rectangular recess (90) which further defines a substantially square aperture (92) having rounded corners. The aperture (92) receives therethrough the electronic control system (78), and in FIG. 1 a control panel of the electronic control system (78) is shown. The rectangular recess (90) typically includes, mounted there against, a steel facia (91), as shown in FIG. 15.

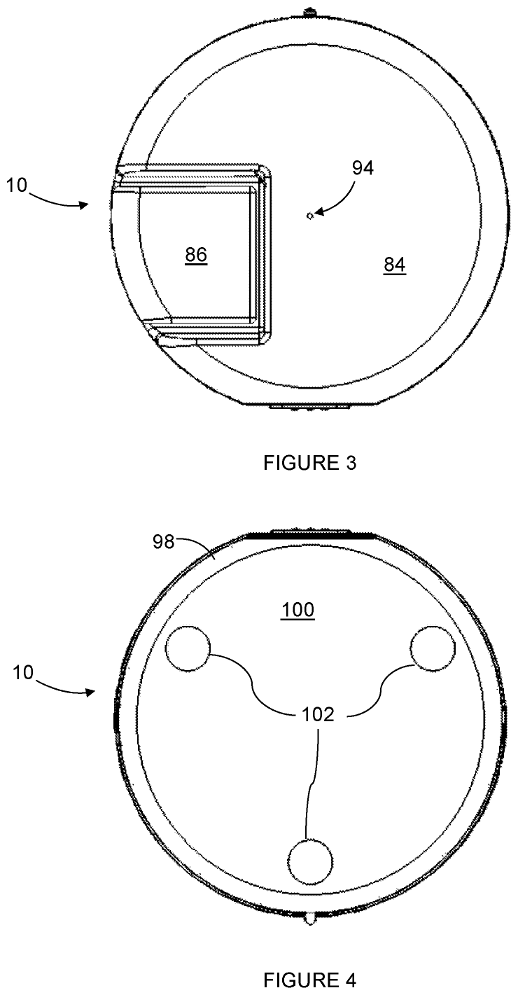

FIGS. 1 and 3 further show the cowl (22) having a first hole (94) in a centre of its flat circular top surface (84). The first hole (94) superposingly located relative to a corresponding second hole (96) located through the L-shaped arm (44) and/or the U-shaped arm (42) of the bracket (40), as shown in FIG. 11. Conventionally, the first and second holes (94, 96) are screw threaded such that a screw can be located therethrough tightening the cowl (22) against the bracket (40) therein ensuring the cowl (22) is not easily displaced away from the reservoir (12) to unnecessarily expose the heat pump assembly (14).

FIGS. 1 and 2 show a top and bottom perspective view of an electric water heating apparatus (10), respectively. The shape of the water reservoir (12) together with the cowl is generally vertically cylindrical having round side walls. The bottom end (105) of the reservoir forms an inwardly sloping ridge (98) before providing a substantially circular flat base portion (100). The circular flat base (100) includes three circular feet (102) spaced apart to form a triangle. When in use, the apparatus (10) may stand on a flat surface resting on its three feet (102). The reservoir (12) and the cowl (22) together provide a near flat face (104) running along a length of both the reservoir (12) and the cowl (22). This near flat face (104) is divided into an upper section (104.1) (provided as the steel facia (91) over the rectangular recess (90)) and a bottom section (104.2), and together provides for an operatively front face of the apparatus (10). This is shown in FIGS. 1 and 5.

FIG. 3 shows a top view of the apparatus (10) with the lid (86) and the first hole (94) for securing the cowl (22) to the bracket (40). FIG. 4 shows a bottom view of the apparatus (10) with the three spaced feet (102) on the base portion (100), and the inwardly sloping ridge (98). The base portion (100) has a smaller diameter relative to the cylinder forming the reservoir (12).

FIG. 5 shows a front view of the apparatus (10) and shows toward the centre of the reservoir (76) a near square section (106). Typically, behind the square section (106), which is readily removable, there is located the water heating element (74).

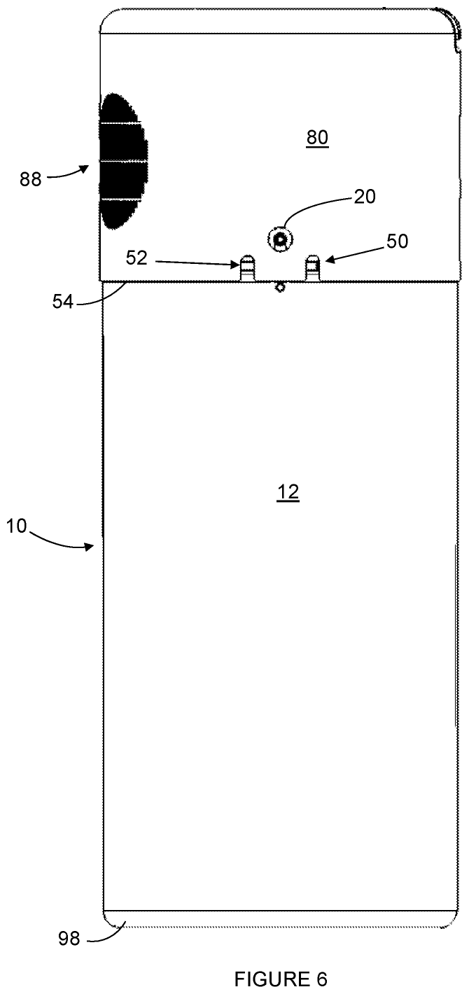

FIG. 6 shows a back view of the apparatus (10). The second inlet (50) is shown which allows, in use, cold water to flow into the water heating conduit (18), and the second outlet (52) is shown through which hot water flow out of from the water heating conduit (18). A person skilled in the art would appreciate that the placement of the second inlet (50) and second outlet (52) may vary and need not be as illustrated.

The apparatus (10) may include several additional features, such as an emergency outlet overflow for the reservoir (12) in case it overfills or experiences an increase in pressure.

The apparatus (10) may be connected to a renewable energy source, such as solar panels. The direct current made via solar technology may be inverted to alternating current before powering the apparatus (10).

The Applicant has found that the electric water heating apparatus (10) according to this disclosure allows for indirect heating of water inside the water heating conduit (18) such that the heated water may be at high pressure for use throughout the water reticulation network.

The water reservoir (12) remains under relatively low pressure when compared to the water inside the water heating conduit. Preferably, the water reservoir (12) remains under near, or substantially near, atmospheric pressure.

The low pressure heated water inside the reservoir (12) is never contacted by an end user.

As such, any biological fouling around the condenser coil (16) and/or water heating conduit (18) is not a risk for the end user. Periodically, the water inside the reservoir (12) may be emptied, the reservoir may be cleaned, and fresh water may again be allowed fill the reservoir (12) via the first inlet (20).

Having the water reservoir (12) under constant low (atmospheric) pressure allows the manufacture of its inner sleeve (28) to be of a plastics-containing material, such as fibreglass. The water reservoir does not have to be a pressure vessel, since the water therein is not contained at a pressure elevated above atmospheric pressure. The invention ameliorates the need for a high strength metallic water reservoir which is ordinarily required to sustain a high-pressure environment. Consequently, the water reservoir (12) is lightweight relative to an ordinary electric geyser and is easy to install.

The inclusion of the ribbed sections in the condenser coil and in the water heating conduit, at least to some extent, facilitates turbulent flow therethrough and/or to limit scale accumulation and/or to limit biological fouling.

The electric water heating apparatus (10) according to this disclosure allows for the production and use of high-pressure hot water heated via indirect means.

The Applicant believes that the subject matter of the disclosure described herein at least ameliorates one of the disadvantages known in the current state of the art.

While the subject matter of the disclosure has been described in detail with respect to specific embodiments and/or examples thereof, it will be appreciated that those skilled in the art, upon attaining an understanding of the foregoing may readily conceive of alterations to, variations of and equivalents to these embodiments. Accordingly, the scope of the present disclosure should be assessed as that of the claims and any equivalents thereto, which claims will be appended hereto upon completion of this application.

1-10. (canceled)

11. An electric water heating apparatus, comprising:
a water reservoir having a closable aperture for receiving water therein;
a heat pump assembly including at least a portion of a condenser coil located inside the water reservoir, operatively enabling a compressed refrigerant to flow through the condenser coil for heat exchange to take place between the condenser coil and the water inside the reservoir to heat the water inside the reservoir; and
a water heating conduit extending at least partly through the water in the water reservoir, operatively conveying water therethrough between an inlet and an outlet and being in fluid communication with a water reticulation network, for water passing though the water heating conduit to be indirectly heated via heat transfer from heated water inside the water reservoir.

12. The electric water heating apparatus of claim 11, further comprising an outer sleeve, and an inner sleeve formed from a plastics-containing material.

13. The electric water heating apparatus of claim 12 wherein the plastics-containing material includes a fiber reinforced plastics-containing material.

14. The electric water heating apparatus of claim 13 wherein the fiber reinforced plastics-containing material includes fiberglass.

15. The electric water heating apparatus of claim 12 wherein the outer sleeve of the water reservoir is configured as an insulation layer.

16. The electric water heating apparatus of claim 15 wherein the insulation layer includes a plastics material.

17. The electric water heating apparatus of claim 16, wherein the plastics material includes at least one of polyurethane, polystyrene, or a derivative thereof.

18. The electric water heating apparatus of claim 11 wherein the condenser coil is internally ribbed to facilitate turbulent flow of water therethrough.

19. The electric water heating apparatus of claim 11 wherein the water heating conduit is ribbed to facilitate turbulent flow of water therethrough.

20. The electric water heating apparatus of claim 11 wherein the inlet and the outlet are located proximal to a top end of the water reservoir, with the inlet and outlet having therebetween a downwardly spiraling portion of the water heating conduit and an upwardly spiraling portion of the water heating conduit, with the downwardly spiraling portion being proximal to a second inlet, and the upwardly spiraling portion being proximal to a second outlet, for water passing through the conduit to be indirectly heated as the water spirals upwardly toward the second outlet.

21. The electric water heating apparatus of claim 11 wherein the water conduit inlet is located proximal to a lower end of the water reservoir, and the water heating conduit outlet is located proximal to a top end of the water reservoir, for water passing through the conduit rises upwardly toward a second outlet as the water is heated.

22. The electric water heating apparatus of claim 11, further comprising a backup electrical water heating element located within the water reservoir.

23. The electric water heating apparatus of claim 22 wherein the backup electrical water heating element is proximate to a bottom end of the water reservoir.
